(19) United States
(12) Patent Application Publication
(10) Pub. No.: US 2026/0309216 A1
(43) Pub. Date: Oct. 8, 2026

(54) DRIVE ASSEMBLY

(71) Applicant: GKN Automotive Limited, Birmingham, West Midlands (GB)

(72) Inventors: Jan Haupt, Lohmar (DE); Theodor Gassmann, Lohmar (DE); Maximilian Werkhausen, Lohmar (DE)

(21) Appl. No.: 18/998,268

(22) PCT Filed: Jul. 26, 2022
(86) PCT No.: PCT/EP2022/071013

§ 371 Date: Jan. 24, 2025

(51) Int. Cl. F16H 48/26; F16H 48/22; F16H 57/04

(52) U.S. Cl. CPC F16H 48/26; F16H 48/22; F16H 57/0424; F16H 57/0435; F16H 57/045; F16H 57/0483; F16H 2048/265

(57) ABSTRACT

A drive assembly for a motor vehicle, comprising: a gearing, a friction clutch, a housing with a reservoir in which lubricant can be stored during operation, a valve with a setting member for controlling a lubricant flow from the reservoir to the clutch housing, with the setting member being movable by an actuating contour, an actuator with a ramp mechanism with a rotatably drivable setting ring and a rotationally fixed support ring, which have a ramp structure, wherein the setting ring is connected to the actuating contour, wherein by rotating the setting ring from an initial rotation angle to an intermediate rotation angle the valve is fully opened and the friction clutch is transferred to a partially closed position, and by rotating in a second range of rotation beyond the intermediate rotation angle, a transmissible clutch torque can be variably adjusted and the valve remains open.

### TECHNICAL FIELD

The disclosure relates to a drive assembly with a gearing and a controllable clutch and an oiling system, which may be for a driveline of a motor vehicle. Drive assemblies with a gearing and controllable clutch are used in drivelines for transmitting power between several drive components, such as drive shafts and/or drive wheels. They may enable the transmission of rotary movements, variable torque transmission and/or connecting or disconnecting of drivetrains.

### BACKGROUND

From EP 3 763 972 A1, a drive assembly for a motor vehicle driveline is known comprising a gearing, a clutch connected to the gearing and a ramp mechanism for controlling the clutch. A reservoir is provided in which lubricant can be temporarily stored and a valve for controlling the flow of lubricant from the reservoir to the gearing and clutch housing. The valve is operatively connected to the ramp mechanism so that lubricant flows from the reservoir to the housing chamber when the clutch is closed and lubricant is stored in the reservoir when the clutch is not actuated.

From DE 10 2005 053 555 B3, a ball ramp assembly for actuating a friction clutch is known, which has two ramp discs with a plurality of ball grooves extending in the circumferential direction, in each of which a ball is accommodated, via which the ramp discs are axially supported. The ball grooves have a first groove section with a greater pitch and an adjoining second groove section with a smaller pitch.

It is an object of at least some implementations of the present disclosure to propose a drive assembly with a gearing and a clutch that enables the oil supply to be adapted to the demand and has a high efficiency and/or low power losses.

### SUMMARY

As a solution, a drive assembly for a motor vehicle is proposed, comprising: a gearing; at least one friction clutch which is drivingly connected to the gearing and is designed for variable torque transmission between a clutch input part and a clutch output part; a housing having a gearing housing chamber in which the gearing is accommodated, a reservoir in which lubricant can be stored, and a clutch housing chamber in which the friction clutch is accommodated, lubricant being conveyed from the gearing housing chamber and/or clutch housing chamber into the reservoir during operation due to rotational movement of a component rotating in the housing; a valve with a setting member for controlling a lubricant flow from the reservoir to the clutch housing chamber, wherein the setting member is movable by an actuating element with an actuating contour, wherein lubricant flows from the reservoir into the clutch housing chamber when the valve is open, and lubricant is temporarily stored in the reservoir and the amount of lubricant circulating in the housing is reduced when the valve is closed; an actuator for controlling the friction clutch and the valve, wherein the actuator has a ramp mechanism with a rotatably drivable setting ring and a support ring supported in direction of rotation, with a ramp structure, so that at least in a rotational range a rotational movement of the setting ring is converted into a translational movement, and wherein the setting ring is drivingly connected to the actuating element; wherein the ramp structure and the actuating contour are designed such that by rotating the setting ring from an initial rotational position, in which the setting ring and the support ring are arranged close to each other, into an intermediate rotational position, the valve is fully opened and the friction clutch is transferred from a fully open to a partially closed position, and by further rotation of the setting ring in a second rotational range beyond the intermediate rotational position up to a final rotational position, the torque that can be transmitted by the friction clutch is variably adjustable, wherein the valve remains fully open.

An advantage of the drive assembly is that a particularly high cooling and lubrication performance may be achieved for the clutch. The controllable oil flow is very well adapted to the needs of the clutch. When the clutch is active, the full oil flow can be provided at the right time so that the clutch is well lubricated and cooled. Coupling is provided between different shift positions of the clutch and different shift states of the valve, depending on the angle of rotation of the setting ring. When the clutch is disconnected, i.e. fully open, part of the lubricant is temporarily stored in the reservoir so that the amount of lubricant circulating in the gearing and thus also the splash losses are reduced. The reservoir, which is at a higher level than the sump of the gearing housing and/or clutch housing, is filled by one or more rotating components of the gearing, for example a gear wheel, and/or of the clutch, for example a disc carrier. When the drive assembly is in operation, gearing parts and clutch parts rotate in their respective housing chambers and, due to the rotational movement, pick up lubricant and convey and/or spin it towards the reservoir. The lubricant is temporarily stored in the reservoir and returns to the circuit when the valve is open.

An initial position can be defined in that the setting ring having the smallest distance to the support ring. The valve is fully closed and the clutch is fully open. From this starting position, the setting ring can be rotated over a first rotation angle range in which the valve is fully open. This position, in which the valve is fully open, corresponds to the intermediate angle of rotation. The ramp structure is designed such that the clutch is only partially closed when the setting ring is rotated in the first rotation angle range. When the intermediate angle of rotation is reached, the clutch cannot yet transmit any significant torque. For example, the ramp structure can be designed so that a torque that can be transmitted by the friction clutch at the intermediate angle of rotation is less than 10 %, which may be less than 5 % of the maximum torque that can be transmitted by the friction clutch when it is fully closed. This includes the possibility that the clutch does not yet transmit any torque in the intermediate rotational position of the setting ring.

In the context of the present disclosure, a support ring that is at least supportable in the direction of rotation is intended to include that it is always supported relative to a housing part in the direction of rotation or that it is rotatable to a limited extent in the housing and is supportable against a stop on the housing side in the direction of rotation. In either case, the support ring is designed to support an applied torque. For this purpose, the support ring can be fixed in the housing so that it cannot rotate, or it can be mounted in the housing so that it can rotate to a limited extent.

According to an implementation, the friction clutch has a disc pack and a pressure plate for pressing the disc pack against a support plate. The pressure plate can be moved axially by the setting ring from an open position, in which the friction clutch is fully open, via a response position, in which an air gap in the clutch is bridged, to a closed position, in which the clutch is fully closed. The ramp structure of the ramp mechanism may be designed such that the pressure plate is moved at least approximately into the response position by turning the setting ring to the intermediate rotation angle, i.e. within a tolerance of plus minus 10% of the total travel between the open position and the closed position around the response position. The response position can be defined as the position at which the friction clutch starts to drag and/or starts to transmit a torque. In particular, the ramp structure can be designed such that the air gap of the clutch is bridged by at least 90 % when the intermediate position is reached. Alternatively or additionally, the functional travel of the clutch between the response position and the end position can be bridged by at most 10 %.

For fast response behaviour, a first rotation angle range between the initial rotation angle and the intermediate rotation angle can be smaller than a second rotation angle range in which the torque to be transmitted by the friction clutch is variably adjustable until the final rotation angle is reached. The second rotation angle range, which comprises larger setting angles than the intermediate rotation angle, can directly follow the first rotation angle range. The second rotation angle range may be greater than 1.5 times and/or less than 5 times the first rotation angle range. The first rotation angle range can, for example, be greater than 3° and less than 30°.

Several implementations of the ramp structure are possible. The ramp structure can have a uniform pitch over the entire rotation path, i.e. the first and second rotation angle range. Alternatively, the ramp structure can have an average gradient in the first rotation angle range that is greater than an average gradient in the second rotation angle range. This achieves a particularly fast response behaviour. The two options apply in particular to implementations in which the setting ring is permanently held so as to be rotationally fixed in the housing. In an implementation in which the support ring can rotate to a limited extent and is supportable against a stop on the housing side, the ramp structure only requires one pitch section to actuate the friction clutch. In the first rotation angle range, both rings rotate together, wherein the valve is fully opened. After the support ring stops against the rotation stop, the setting ring is rotated further against the support disc, wherein the balls run into the inclines in this second rotation angle range and the ball ramp is spread so that the clutch is actuated.

According to a possible embodiment, the fully open state of the valve is defined by an axial end stop of the setting member. The setting member can be loaded against the end stop by a spring.

The actuating contour of the actuating element, which can also be referred to as control contour, interacts with the valve actuator to move it when the setting ring is rotated in the first rotation angle range. When the actuating ring is rotated in the second rotation angle range, which corresponds to the functional range of the friction clutch, the actuating element may be contactless to the valve actuator. This leads to a low energy requirement of the actuator, as friction between the valve actuator and the actuating element is avoided. Wear is also minimised. Starting from the initial position, in which the valve is closed and the clutch is open, the valve actuator is released by the actuating element and moved into the open position by the spring when the setting ring is turned in a first direction of rotation, so that a fluid connection from the reservoir to the clutch chamber is opened. When the setting ring is turned in the second direction of rotation to open the clutch, the valve actuator is moved into the closed position by the actuating element against the preload force of the spring, starting from the intermediate position. This closes the valve again.

The actuating element may be designed in one piece with the setting ring, although a design as a separate element is also possible, in which case the actuating element and setting ring would then be operatively connected to each other. The actuating contour of the actuating element and the ramp structure of the setting ring may be configured such that a movement of the setting ring to close the clutch is accompanied by a movement of the valve actuator to open the valve. The arrangement of the valve in relation to the actuating element and/or the control contour is in principle arbitrary and can be adapted to the installation space conditions. For example, the valve can be arranged such that the valve axis crosses the axis of rotation of the setting ring at a distance or intersects it. The control contour can lie in a radial plane or at an angle to a radial plane in relation to the axis of rotation of the setting ring.

The ramp assembly may be designed as a ball ramp, wherein various implementations are possible. One of the setting ring and the support ring is axially supported and the other is axially displaceable. The setting ring and the support ring each have a plurality of ball grooves extending in the circumferential direction on their mutually facing end faces which, in plan view of the end faces, respectively have a decreasing depth in the same circumferential direction, starting from an area of greatest groove depth. A ball is accommodated in each pair of opposing ball grooves, via which the setting ring and the support ring are axially supported against each other. The ramp structure converts a rotary movement of the setting ring into an axial movement to spread the ball ramp assembly. According to a first embodiment, the support ring is held in the housing so that it cannot rotate. According to a second embodiment, the support ring is limitedly rotatable in the housing and can strike against a rotational stop on the housing side. In the second embodiment, the actuating element with control contour can be arranged either on the setting ring or on the support ring.

Indexing means may be provided to define a zero-point position of the ball ramp mechanism. In this way, the “valve closed” position can be securely maintained even when de-energised. For example, at least a partial number of the ball grooves can have indexing recesses in the area of their greatest groove depth, into which the associated balls can engage in order to define the zero-point position in the initial rotational position. Alternatively, a latching function can be provided in the control area of the setting ring, which defines the zero-point position.

According to an embodiment, a connecting channel is provided from the gearing housing chamber to the reservoir. When installed, the opening of the connecting channel into the reservoir can be at a higher level than the opening of a connecting channel from the reservoir. The gearing can be configured as an angular drive and comprise a rotationally drivable pinion and a ring gear engaging therewith, which is mounted in the gearing housing so as to be rotatable about an axis of rotation. A collecting device can be provided in the gear housing chamber to collect lubricant thrown off by the ring gear and feed it to the connecting channel.

### BRIEF DESCRIPTION OF THE DRAWINGS

Certain embodiments are explained below with reference to the drawing figures. Herein it is shown in:

FIG. 1 a perspective view of a drive assembly;

FIG. 2 the drive assembly from FIG. 1 in a longitudinal section;

FIG. 3 a perspective view of the arrangement of the lubricant chambers of the drive assembly from FIGS. 1 and 2;

FIG. 4 a detail of the drive assembly from FIGS. 1 and 2 in a section through the valve and a channel;

FIG. 5 a detail of the drive assembly from FIGS. 1 and 2 in an oblique section through the reservoir;

FIG. 6A the valve actuation of the drive assembly from FIGS. 1 and 2 in a first rotational position with the valve closed according to section line VI-VI from FIG. 4;

FIG. 6B the valve actuation from FIG. 6A in an intermediate position with the valve open;

FIG. 6C the valve actuation from FIG. 6A in a further rotational position with the valve open;

FIG. 7 a status diagram of the ramp setting ring and valve setting member as a function of the angle of rotation of the setting ring;

FIG. 8A a ball groove of the ramp mechanism from FIG. 2 in a circumferential section through the groove base;

FIG. 8B a ball groove of a ramp mechanism in circumferential section through the groove base for an assembly according to FIG. 2 in a modified embodiment;

FIG. 9A the assembly from FIG. 6 in a modified embodiment in a simplified representation with closed valve;

FIG. 9B the assembly from FIG. 9A with the valve open;

FIG. 9C the assembly from FIG. 6 in a further modified embodiment with closed valve;

FIG. 10 a further detail of the drive assembly from FIGS. 1 and 2 in a sectional view;

FIG. 11 a further detail of the drive assembly from FIGS. 1 and 2 in a sectional view;

FIG. 12A the drive assembly from FIGS. 1 and 2 in a further perspective sectional view;

FIG. 12B a detail from FIG. 12A in an enlarged sectional view;

FIG. 13A a part of the drive assembly from FIGS. 1 and 2 in a perspective sectional view;

FIG. 13B a detail from FIG. 13A in an enlarged sectional view;

FIG. 14 a driveline with drive assembly according to FIGS. 1 to 13 in a schematic representation; and

FIG. 15 a drive assembly in a second embodiment in a schematic representation.

### DETAILED DESCRIPTION

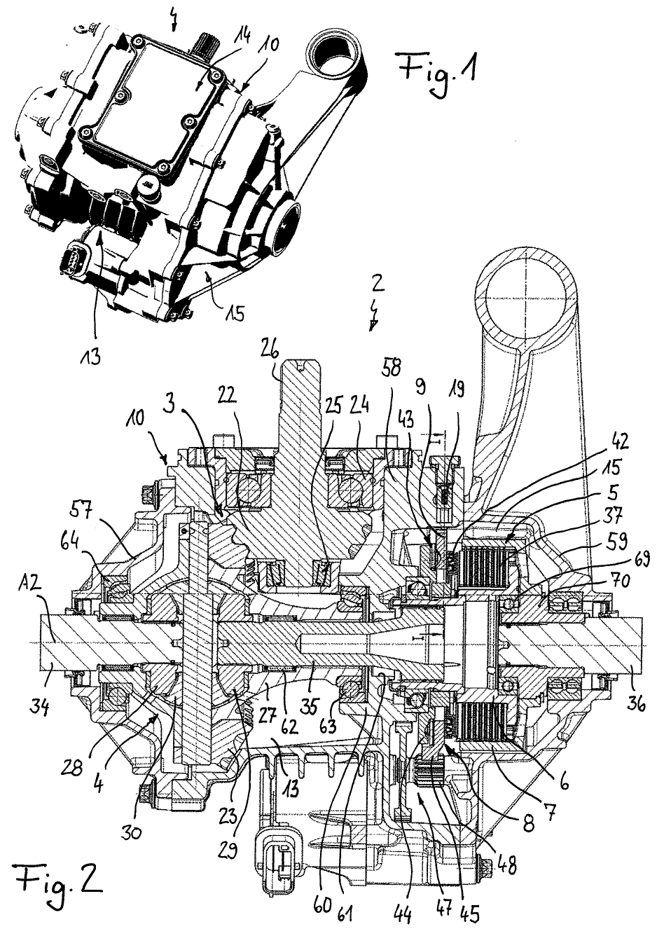

FIGS. 1 to 13B, which are described together below, show a drive assembly 2 for a driveline of a motor vehicle. The drive assembly 2 comprises a first gearing 3, which may be designed in the form of an angular drive, a second gearing 4 downstream in the power path which is optional and is designed in the present case in the form of a differential gearing, and a clutch 5, which is drivingly connected to the first and/or second gearing and is designed for variable torque transmission between a clutch input part 6 and a clutch output part 7. To control the clutch 5, an actuator 8 with a ball ramp mechanism 43 is provided, which acts on the clutch 5 to adjust the torque transmittable between the clutch parts 6, 7.

The drive assembly 2 also comprises a housing 10 with a gearing housing chamber 13, in which the first gearing 3 or parts thereof is accommodated, a reservoir 14 and a clutch housing chamber 15, in which the clutch 5 is accommodated. The gearing housing chamber 13 is fluidically connected to the reservoir 14, in particular via a fluid channel 12, so that lubricant is conveyed from the gearing housing chamber 13 into the reservoir 14 during operation. The reservoir 14 is fluidically connected to the clutch housing chamber 15, in particular via one or more further fluid channels 16, 17, 18, so that lubricant can flow from the reservoir 14 to the clutch housing chamber 15. The reservoir 14 can be designed such that it can temporarily store at least 25 % of the total lubricant, for example about 50 % of the total lubricant.

Oil is provided in the housing 10, which serves to dissipate heat generated by the friction and to lubricate the components that come into frictional contact with each other. A switchable valve 19 is provided to control the lubricant flow from the reservoir 14 to the clutch housing 15. The valve 19 is operatively connected to the actuator 8 in such a way that the valve is opened when the clutch 5 is closed, so that lubricant flows from the reservoir 14 to the clutch housing chamber 15, and is closed when the clutch 5 is open, so that lubricant is temporarily stored in the reservoir 14.

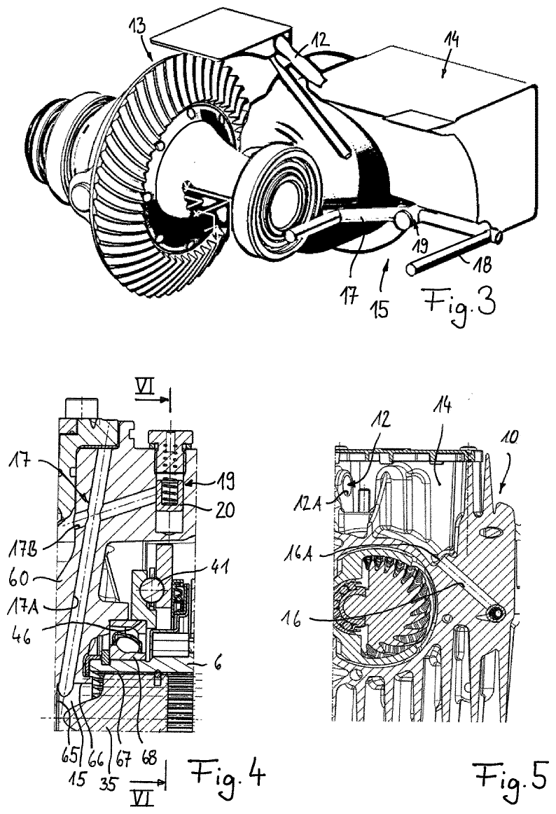

As can be seen in particular in FIG. 3, the chambers 13, 14, 15 are arranged in series and hydraulically connected to each other, so that during operation a lubricant flow is established from the first chamber 13 to the second chamber 14 and—when clutch 5 is actuated—to the third chamber 15. The lubricant flow to clutch 5 is controlled via valve 19, which is operated by the movement of actuator 8. When clutch 5 is active, i.e. when it transmits torque, valve 19 is open and the oil flow to clutch chamber 15 is enabled. The full volume of lubricant is therefore available for lubricating and/or cooling the rotating components. When the clutch 5 is inactive, i.e. when it is open and not transmitting torque, the valve 19 is closed so that the return flow of lubricant is interrupted and the reservoir 14 fills with lubricant. As a result, the lubricant level in the gearing chamber 13 drops steadily so that the splash losses are low.

The first gearing 3 includes a first and second gear 22, 23, which are in meshing engagement with each other. In the present embodiment as an angular drive, the first gear 22 is designed as a pinion and the second gear 23 is designed as a ring gear. The first gear 22 can be designed in one piece with a shaft journal and can be mounted rotatably about an axis of rotation in the housing 10 by one or more bearings 24, 25. Torque can be introduced via shaft splines 26 at the end of the journal, for example from a driveline that is drivable by an electric machine or an internal combustion engine.

The second gear 23 is firmly connected to the input part 27 of the differential gearing 4, for example via a bolted and/or welded connection. The differential gearing 4 distributes an introduced drive torque from the input part 27 evenly to two output parts 28, 29. The differential gearing 4 comprises a differential cage as input part, several differential gears 30, which rotate together with the cage around the axis of rotation A2, and two side shaft gears as output parts 28, 29, which are in meshing engagement with the differential gears and are rotatably mounted in the differential cage coaxially to the axis of rotation A2. The left-hand side shaft gear 28 is connected to the left-hand side shaft 34 for torque transmission. The right-hand side shaft gear 29 is connected to the right-hand shaft 36 for torque transmission via an intermediate shaft 35 and the clutch 5. The outer ends of the shafts 34, 36 can be connected to vehicle wheels via side shafts.

It can be seen in particular in FIG. 2 that the controllable clutch 5 is arranged in the power path between the differential gearing 4 and the shaft 36. A first function of the clutch 5 is that the drive torque for driving the drive axle can be set therewith, in particular variably depending on the determined requirement (target torque). Furthermore, the shafts 34, 36 and/or the associated drive axle on the one hand and the drive source on the other can be connected to or disconnected from each other by the clutch 5 as required. The clutch 5 is designed in the form of a wet-running friction clutch, which enables infinitely variable adjustment of the torque that is transmittable between the clutch input part 6 and the clutch output part 7. In the closed state, the shaft 36 is connected to the intermediate shaft 35 of the differential gearing 4 for torque transmission. When the clutch 5 is open, the shaft 36 is mechanically disconnected from the differential gearing 4 so that no torque can be transmitted to the vehicle wheels. The clutch 5 can be continuously adjusted to any intermediate position between the closed position and the open position, so that the torque transmitted to the right and left shafts 34, 36 can be adjusted and controlled.

The friction clutch 5 comprises an inner disc carrier as input part 6, to which inner discs are connected in a rotationally fixed and axially movable manner, and an outer disc carrier as output part 7, to which outer discs are connected in an axially movable and rotationally fixed manner. The outer and inner discs are arranged in an axially alternating manner and together form a disc pack 37. The disc pack 37 is axially supported in a first axial direction against a support plate 38. In the present embodiment, the support plate 38 is formed in one piece with the inner disc carrier 6, without being restricted thereto. A pressure plate 39, which is axially movable by the controllable actuator 8, is provided for applying pressure to the disc pack 37.

The torque transmissible by the clutch 5 can be determined for example in an electronic control unit (ECU) on the basis of continuously sensed driving state variables of the motor vehicle. The electronic control unit transmits a respective control signal to the actuator 8, which then acts on the pressure plate 39 accordingly so that the desired torque is transmitted by the clutch 5.

An axial bearing 42 is provided between the actuator 8 and the clutch 5, which enables axial force transmission from the actuator 8 to the pressure plate 39 while simultaneously providing rotational decoupling. In the present case, the actuator 8 comprises a ball ramp mechanism 43 and a drive unit (not shown). The ball ramp mechanism 43 includes a support ring 44, which is axially supported against a housing part 60 and held in a rotationally fixed manner, as well as an setting ring 45, which is opposite the support ring and is rotationally drivable about the axis of rotation A2. The support ring 44 is received with an inner seat 46 on the bearing 68. The setting ring 45 is rotatably drivable by a drive source, for example an electric motor, via a gear stage 47.

Ball grooves 40, 49 distributed around the circumference are arranged in the mutually opposing end faces of the support ring 44 and setting ring 45. The ball grooves 40, 49 have a variable depth over the circumference and each accommodate a ball 41, via which the rings are axially supported against each other. At least some of the ball grooves 40, 49 have an indexing recess 50 in the area of their greatest groove depth in order to define a zero-point position of the ball ramp mechanism. To actuate the ball ramp unit 43, the setting ring 45 is rotated relative to the support ring 44 via the gear stage 47. The gear stage comprises a first gear drivable by the drive source and a pinion 48 connected thereto, which is engaged with an external toothing 49 of the setting ring 45.

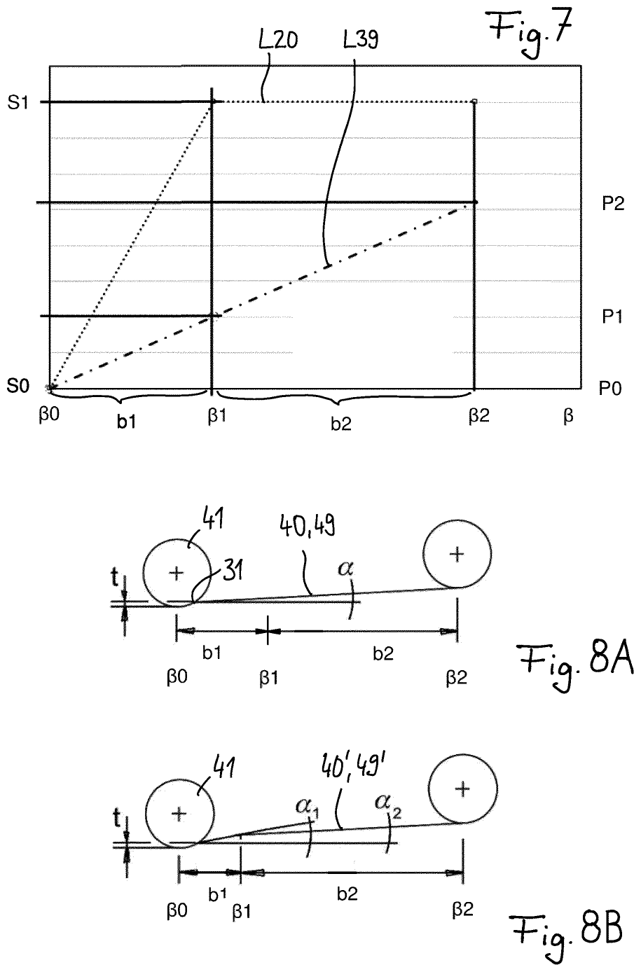

An exemplary ball groove 40, 49 is shown in FIG. 8A, which has a uniform pitch angle α over the entire rotation path β1 and β2. An alternative ball groove 40′, 49′ is shown in FIG. 8B. Here, the ball groove in the first rotation angle range b1 has an average pitch angle α2 that is greater than the average pitch angle α2 in the second rotation angle range b2. For both configurations, the second rotation angle range b2 is larger than the first rotation angle range b1, for example 1.5 to 5 times larger.

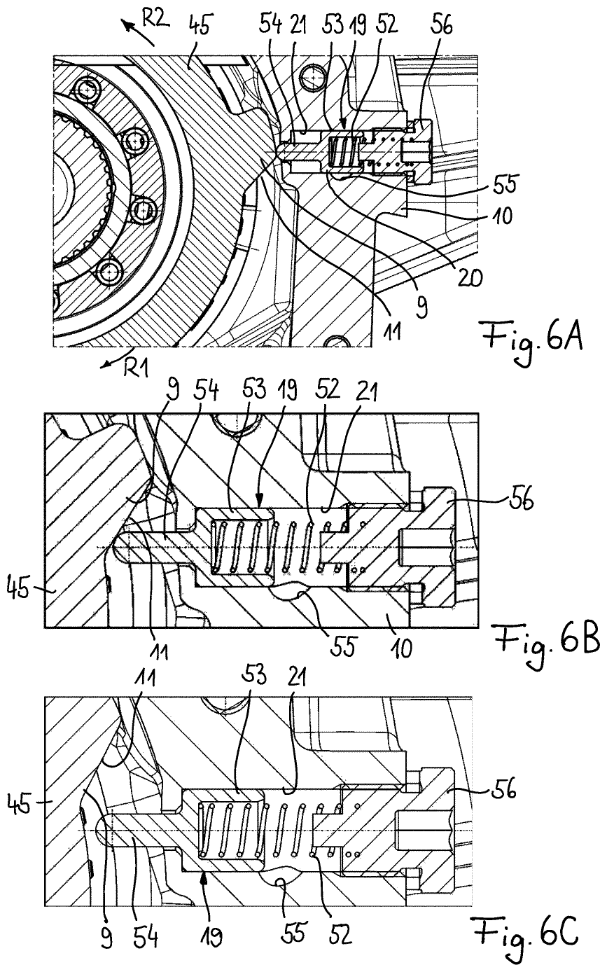

As can be seen in particular in FIG. 6A, the actuating element 9 for the valve 19 is firmly connected to the rotatable setting ring 45 and/or is formed in one piece with the latter. In the present embodiment, the actuating contour 11 of the actuating element 9 is formed on an outer circumferential face, which means that the valve 19 is aligned essentially radially and/or perpendicularly relative to the axis of rotation A2 of the setting ring 45. Other embodiments are also possible, for example that the actuating contour of the actuating element is formed on an end face of the setting ring. In this case, the valve would be arranged substantially parallel to the axis of rotation A2 of the setting ring.

The valve 19 comprises an axially movable setting member 20, which is axially movably seated in a valve chamber 21. The setting member 20, which can also be referred to as a valve body, can be preloaded by a spring 52 in the direction of the actuating element 9. The setting member 20 comprises a first section 53, in particular with a larger diameter, which can close or open at least one fluid orifice 55 to the valve chamber 21, and a second section 54, in particular with a smaller diameter, the end of which is in contact with the actuating contour 11 of the actuating element 9. The setting member 20 is supported via the spring 52 against a support element 56, which closes the valve chamber to the outside. For this purpose, the support element 56 is designed in the form of a screw member screwed into the housing 10, against which the spring 52 is supported. The spring preload can be set by adjusting the screw-in depth of the screw member. When the clutch 5 is open, the setting member 20 is pressed radially outwards by the actuating contour 11 of the actuating element 9 against the preload force of the spring 52, so that the valve 19 is closed. This state is shown in FIG. 6A. To close the clutch 5, the actuating element 9 is rotated (anti-clockwise in FIG. 6A), wherein the setting member 20 slides along the actuating contour 11 and is pressed radially inwards by the spring 52. In this way, the setting member 20 releases the fluid orifice 55 to the valve chamber 21 so that the lubricant drains from the reservoir 14 and the full amount of lubricant is available.

The movements of the setting member 20 through the actuating contour 11 and the pressure plate 39 through the ramp contour are kinematically coupled with each other. This relationship is shown in FIG. 7, where the dotted line L20 shows the movement of the valve setting member 20 and the dotted line L39 shows the axial movement of the pressure plate 39 respectively the setting ring 45, in each case depending on the angle of rotation β of the setting ring 45. When the setting ring 45 is rotated from the initial rotational position β0, in which the setting ring 45 and the support ring 44 are the smallest distance apart, to an intermediate rotational position β1, the valve setting member 20 slides along the actuating contour 11 and moves from the open position S0 (FIG. 6A) to the closed position S1 (FIG. 6B). At the same time, the setting ring 45 and thus the pressure plate 39 moves from the open position P0, in which the friction clutch 5 is fully open, to a response position P1, in which the clutch is only partially closed and cannot yet transmit any significant torque. The ramp structure may be designed such that when the angle of rotation β1 is reached, the air gap of the friction clutch 5 is at least largely bridged, for example by at least 90 %. This includes the possibility that the air gap is slightly exceeded so that the clutch can already transmit a small torque of less than 10 % of the maximum torque, for example.

The second rotation range b2, which lies between the intermediate rotation angle β1 and a final rotation angle β2, forms the functional range of the friction clutch 5. In the functional range, the torque transmittable by the clutch can be variably adjusted as required up to the maximum torque by moving the pressure plate 39 between the positions P1 and P2. When the setting ring 45 is rotated in the second rotation range b2, the valve 19 remains fully open. As can be seen in particular in FIG. 6B, the fully open state of the valve is defined by an axial end stop 31 of the setting member 20, against which it is loaded by the spring. FIG. 6C shows the setting ring 45 in a position within the second angle of rotation range b2. Here, the setting member 20 is contactless to the actuating element 9.

The valve 19 controls the lubricant flow from the reservoir 14 to the clutch chamber 15 and is arranged in particular in the hydraulic connection between the aforementioned chambers 14, 15. Specifically, a first fluid channel 16 can extend from reservoir 14 to valve chamber 21 and open into it. Furthermore, a second fluid channel 17 can extend from the valve chamber 21 to the clutch chamber 15. The second fluid channel 17 can have a first branch 17A, which opens into the clutch chamber 15, and optionally a second branch 17B, which opens into the gearing chamber 13. By moving the setting member 20 in the valve chamber 21, the inlet 16 from the reservoir 14 and the outlet 17 can either be hydraulically connected to each other or separated from each other. The valve 19 is operated automatically via the actuating element 9 respectively the actuator 8.

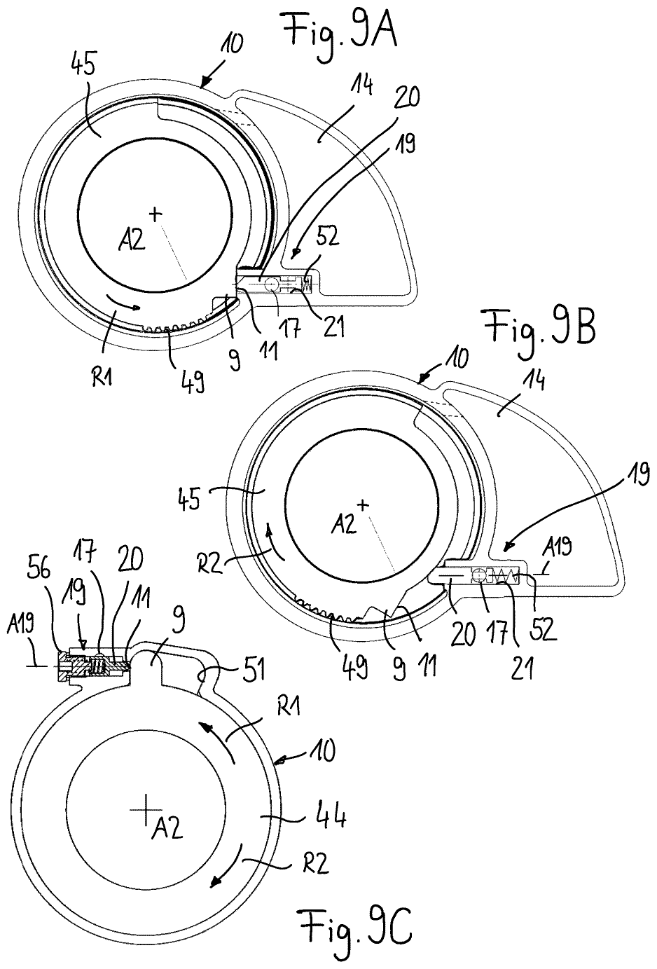

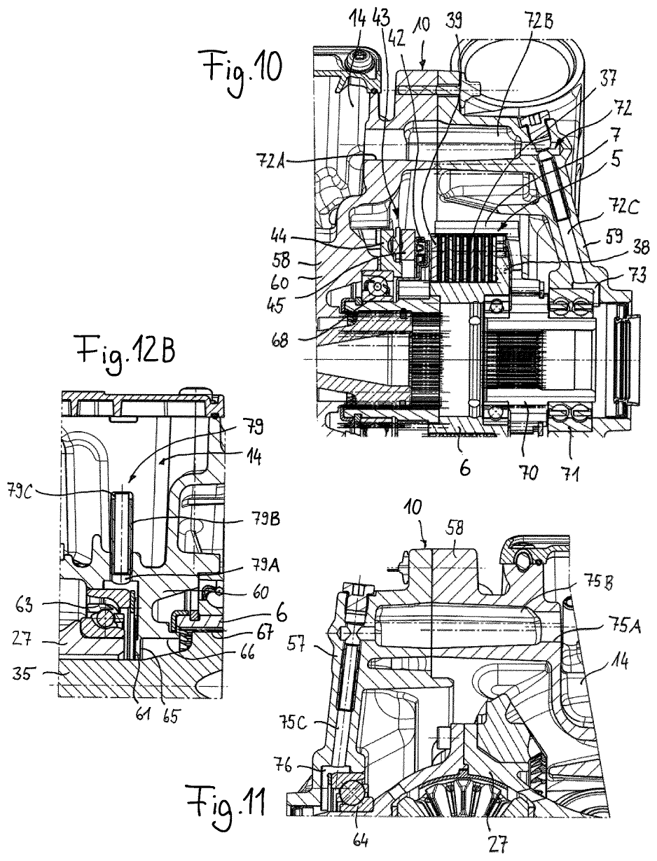

Operating the actuator drive source causes the setting ring 45 to rotate relative to the support ring 44. Depending on the direction of rotation of the drive source, the setting ring 45 can be rotated in the first direction of rotation R1 or in the opposite second direction of rotation R2. In a first operating mode, the two rings 44 and 45 are axially close to each other. The clutch 5 is fully open and the valve 19 is fully closed. This state is shown in FIGS. 6A and 9A.

Starting from this operating state, rotating the setting ring 45 relative to the support ring 44 causes the balls 41 held in the ball grooves to run into areas of lesser depth, so that the setting ring 45 is moved axially in the direction of clutch 5. The setting ring 45 is supported axially against the pressure plate 39 via the axial bearing 42, which is moved accordingly in the direction of the support plate 38. In this way, the clutch 5 is closed and the valve 19 is opened. Such positions are shown in FIGS. 6B, 6C and 9B. By applying pressure to the pressure plate 39, the disc pack 37 is loaded so that a torque is transmitted between the inner and outer disc carriers 6, 7. In this state, the full amount of lubricant is available in the drive assembly 2 to cool or lubricate all rotating components.

If the actuator drive and thus the setting ring 45 is turned again in the opposite second direction of rotation, the balls held in the ball grooves run back into areas of greater groove depth, wherein the setting ring 45 is axially loaded and/or moved in the direction of the support ring 44. In this way, the clutch 5 is opened again and the valve 19 is closed. Part of the total lubricant quantity is temporarily stored in the reservoir 14, so that the active lubricant quantity is reduced in this operating state and splash losses are minimised.

FIG. 9C shows a modified implementation of valve 19 and ball ramp mechanism 43. In terms of structure and mode of operation, this corresponds largely to the embodiments shown in FIGS. 1 to 9B, to the description of which reference is made in terms of similarities. The same and/or corresponding details are provided with the same reference signs as in the figures above. A special feature of the present embodiment is that the actuating element 9 is provided on the support ring 44. The support ring 44 is rotatable to a limited extent, wherein a maximum relative angle of rotation is defined by a stop 51 on the housing side against which the support ring can abut. In the first rotation angle range b1, both rings 44, 45 rotate together, with the valve 19 being fully opened. After the support ring 44 strikes against the rotation stop 51, the setting ring 45 is rotated further relative to the support ring 44 and enters the second rotation angle range b2. The balls 41 in the ball grooves 40, 49 run into the inclined ranges so that the ball ramp unit is spread and the clutch is loaded. The second angle of rotation range b2 forms the functional range of the friction clutch, in which the transmittable torque of the clutch is adjustable, as described above. The ball grooves 40, 49 of the assembly shown in FIG. 9C can be designed, for example, as shown in FIG. 8A.

The setting member 20 of valve 19 is closed when the support ring 44 is rotated in the first direction of rotation R1. When the setting ring 45 is rotated in the second direction of rotation R2, the support ring rotates as far as the rotation stop 51, wherein the valve 19 is fully opened. In the present embodiment, the valve 19 is arranged approximately tangentially to the axis of rotation A2 and/or to the support disc 44. This means that the radially protruding actuating element 9 can simply act on the end of the setting member 20 during rotation to move same. However, the valve 19 can be aligned relative to the support disc 44, as shown in FIGS. 1 to 9B, in which case the actuating element 9 and its actuating contour respectively would have to be adapted accordingly. In a modified embodiment not shown, the valve 19 can also co-operate with the setting ring, which then comprises the actuating element 9.

The housing 10 can, for example, have three housing parts 57, 58, 59, as can be seen in particular in FIG. 2, without being limited thereto. A central housing part 58 forms an intermediate wall 60 between the gearing chamber 13 and the clutch chamber 15. The intermediate wall 60 has an opening 61 through which the intermediate shaft 35 extends, which connects an output part of the differential 4 to the clutch 5 in terms of drive. The intermediate shaft 35 is rotatably mounted in the differential cage 27 by a bearing 62, wherein the differential cage 27 is in turn rotatably mounted in the intermediate wall 60 by a bearing 63. With its opposite end section, the differential cage 27 is rotatably mounted in the cover-shaped housing part 57 by a second bearing 64. As can be seen in particular in FIG. 4, the fluid line 17 opens into an annular section 66 of the intermediate wall 60 axially adjacent to an annular shoulder 65. Lubricant can flow from here to the actuator 8 or clutch 5. The intermediate shaft 35 is connected to the inner disc carrier 6 in a rotationally fixed manner via shaft splines 67. The inner disc carrier 6 is rotatably mounted in the intermediate wall 60 via a first bearing 68 and rotatably mounted on a sleeve part 70 connected to the side shaft 36 via a second bearing 69.

As can be seen in particular in FIG. 10, the sleeve part 70 is rotatably mounted in the housing 10 by the shaft bearing 71. A fluid connection 72 with several sections 72A, 72B, 72C is provided for lubricating the bearing 71, which connects the reservoir 14 with an opening 73 in the region of the bearing 71.

As can be seen in particular in FIG. 11, the differential cage 27 is rotatably mounted in the housing 10 on its side facing away from the angular drive 3 by the shaft bearing 64. A fluid connection 75 with several sections 75A, 75B, 75C is provided for lubricating the bearing 64, which connects the reservoir 14 with an orifice 76 in the region of the bearing 64.

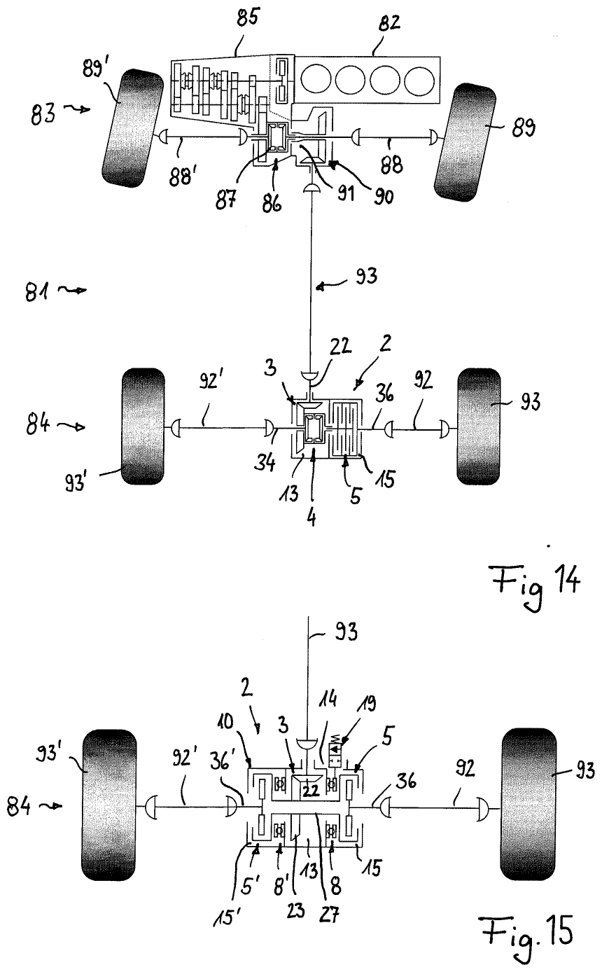

FIGS. 13A and 13B show a further optional detail. To lubricate the bearing 24, 25 of the pinion 22, a fluid connection 77 is provided which connects the reservoir 14 to the pinion chamber 78. In particular, the fluid connection 77 comprises a bore 77A in a lower wall of the reservoir 14, into which a sleeve 77B is inserted. When the level of the lubricant in the chamber exceeds the upper end 77C of the sleeve 77B, the lubricant flows through the sleeve 77B and a bore 77A with opening 77D into the pinion chamber 78 to lubricate the rotating components here.

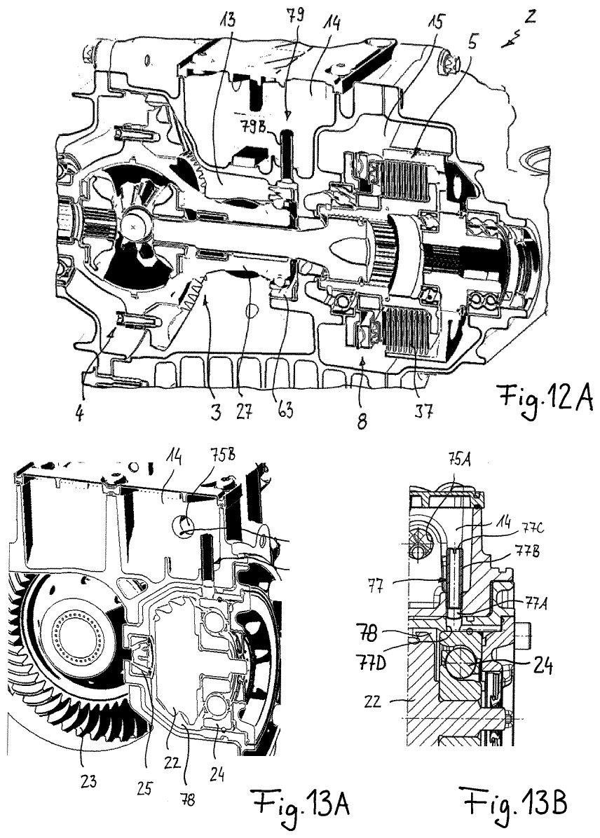

FIGS. 12A and 12B show a further optional detail. A fluid connection 79 is provided for lubricating the bearing 63 of the differential cage 27, which connects the reservoir 14 to the gearing chamber 13. The fluid connection 79 comprises a bore 79A in a lower wall of the reservoir 14, into which a sleeve 79B is inserted. When the level of the lubricant in the chamber exceeds the upper end 79C of the sleeve 79B, lubricant flows through the sleeve and the bore into the gearing chamber 13 to lubricate the bearing 63 and other rotating components.

FIG. 14 shows a driveline assembly 81 for a multi-axle motor vehicle with a drive assembly 2. The driveline assembly 81 comprises a drive source 82, a first driveline drivable by the drive source and having a first drive axle 83, and a second driveline with a second drive axle 84. The drive source 82 is in this case configured in the form of an internal combustion engine and drives a power take-off unit 86 via a multi-step transmission 85, via which torque is introduced into the first and/or second driveline.

The first driveline comprises a differential gearing 87, which transmits an introduced torque to the two side shafts 88, 88′ to drive the associated wheels 89, 89′. The second driveline can be permanently driven (permanent all-wheel drive) or can be configured to be connectable on demand by a clutch 91 arranged in the power path (on-demand drive). The second driveline comprises a multi-part propeller shaft 93, with which torque can be transmitted to the input part 22 of the drive assembly 2. The output parts 34, 36 of the drive assembly 2 are each drivingly connected to a side shaft 92, 92′ to transmit torque to the associated wheels 93, 93′. The drive torque that can be transmitted to the drive axle 84 can be set by the clutch 5, and this can be set variably depending on the determined requirement (target torque). When the clutch 5 is fully open, the side shafts 92, 92′ respectively the associated drive axle 84 are disconnected from the drive. In this operating mode, the reservoir 14 is filled with lubricant so that the lubricant level in the gearing chamber 13 and thus the splash losses are reduced overall.

FIG. 15 shows a drive assembly in a second embodiment. The present embodiment largely corresponds to that shown in FIGS. 1 to 13B in terms of structure and mode of operation, so that reference is made to the above description for the sake of brevity in terms of the similarities. The same and/or corresponding details are indicated with the same reference signs as in the figures above.

A difference is that in the present embodiment, two clutches 5, 5′ are provided with which the torque transmission and distribution to the two side shafts 92, 92′ is controlled. The clutches 5, 5′ can each be controlled individually via an associated actuator 8, 8′. The actuators 8, 8′ and/or clutches 5, 5′ are designed to function in the same way as the corresponding components of the above embodiment, to which reference is made to avoid repetition. An axle differential is not provided in the present embodiment.

The drive assembly 2 comprises the angle drive 3, whose crown gear 23 is drivingly connected to the two clutch input parts 6, 6′ to drive them together at the same speed. The clutch output parts 7, 7′ are connected to the respective associated side shaft 92, 92′ to drive them. The clutch input parts 6, 6′ are designed as outer disc carriers and the clutch output parts 7, 7′ as inner disc carriers. In addition to the disconnect function of the driveline, another special feature of the embodiment with two clutches 5, 5′ is that the torque distribution between the right and left side shafts 92, 92′ can be individually adjusted and controlled. Such an embodiment with one clutch per side shaft is also referred to as a “twinster”. One of the actuators 8 is operatively connected to the valve 19, which is designed as in the above embodiment. The valve 19 can control a lubricant flow to the gearing housing chamber 13, to the first clutch chamber 15 and to the second clutch chamber 15′.

1. A drive assembly for a motor vehicle, comprising:
a gearing,
at least one friction clutch which is drivingly connected to the gearing and is configured for variable torque transmission between a clutch input part and a clutch output part,
a housing with a gearing housing chamber for the gearing, a reservoir which lubricant is storable, and a clutch housing chamber for the friction clutch, wherein, during operation, lubricant is conveyable from at least one of the gearing housing chamber and the clutch housing chamber into the reservoir to a higher level due to rotary movement of a component rotating in the housing,
a valve with a setting member for controlling a lubricant flow from the reservoir to the clutch housing chamber, wherein the setting member is movable by an actuating element with an actuating contour, wherein in the open state of the valve lubricant flows from the reservoir into the clutch housing chamber, and in the closed state of the valve lubricant is stored in the reservoir and the circulating lubricant quantity is reduced,
an actuator for controlling the friction clutch and the valve wherein the actuator includes a ramp mechanism with a rotatably drivable setting ring and an at least rotatably supportable support ring, which have a ramp structure to convert a rotary movement of the setting ring into a translatory movement, and wherein the setting ring is drivingly connected to the actuating element,
wherein the ramp structure and the actuating contour are designed such that by rotating the setting ring from an initial rotation angle, in which the setting ring and the support ring are arranged close to one another, to an intermediate rotation angle, the valve is fully opened and the friction clutch is transferred from a fully open position to a partially closed position, and by rotating the setting ring in a second rotation range beyond the intermediate rotation angle up to a final rotation angle, the torque that can be transmitted by the friction clutch is variably adjustable, with the valve remaining fully open.

2. The drive assembly according to claim 1,
wherein a torque that can be transmitted by the friction clutch when the setting ring is in the intermediate rotation angle is less than 10 % of a maximum torque of the friction clutch.

3. The drive assembly according to claim 1,
wherein the friction clutch has a disc pack and a pressure plate for acting on the disc pack against a support plate
wherein the pressure plate is axially movable by the setting ring from an open position in which the friction clutch is fully open, via a response position, in which an air gap of the friction clutch is bridged, into a closed position, in which the friction clutch is fully closed,
wherein the ramp structure is designed such that the pressure plate is moved at least approximately into the response position by rotating the setting ring into the intermediate rotation angle.

4. The drive assembly according to claim 1,
wherein a first rotation angle range between the initial rotation angle and the intermediate rotation angle is smaller than a second rotation angle range in which the torque to be transmitted by the friction clutch is variably adjustable up to the final rotation angle being reached.

5. The drive assembly according to claim 4,
wherein the second rotation angle range is greater than 1.5 times and less than 5 times the first rotation angle range.

6. The drive assembly according to claim 4,
wherein the first rotation angle range is greater than 3° and less than 30°.

7. The drive assembly according to claim 4,
wherein the ramp structure in the first rotation angle range has an average gradient that is greater than an average gradient in the second rotation angle range.

8. The drive assembly according to claim 1,
wherein a fully open state of the valve is defined by an axial end stop of the setting member, against which the setting member is loaded by a spring.

9. The drive assembly according to claim 8,
wherein the actuating element releases the setting member when the friction clutch is closed, so that the setting member is moved into the open position by the spring against the end stop, and a fluid connection is opened.

10. The drive assembly according to claim 4,
wherein the setting member of the valve interacts with the actuating contour in a contacting manner when the setting ring is rotated in the first rotation angle range, and is contactless with respect to the actuating contour of the actuating element when the setting ring is rotated in the second rotation angle range.

11. The drive assembly according to claim 1,
wherein the actuating element is formed in one piece with the setting ring.

12. The drive assembly according to claim 1,
wherein the actuating element is rigidly connected to the support ring.

13. The drive assembly according to claim 1,
wherein one of the rotatably drivable setting ring and the support ring, supportable in the direction of rotation, is axially supported and the other is axially displaceable,
wherein the setting ring and the support ring have a plurality of ball grooves, 49) extending in the circumferential direction on their mutually facing end faces, which ball grooves each have in plan view of the end faces, starting from a region of greatest groove depth, a decreasing depth in the same circumferential direction, wherein a ball is received in pairs of mutually opposing ball grooves respectively, via which the setting ring and the support ring are axially supported against one another.

14. The drive assembly according to claim 1,
wherein the ramp structure of the setting ring and supporting ring is designed such that, when the setting ring is rotated from the initial rotation angle to the intermediate rotation angle, the supporting ring, supportable in direction of rotation, rotates together with the setting ring, wherein the axial distance between the setting ring and the support ring remains unchanged, and the support ring then comes to rest against a rotational stop, wherein a further rotation of the setting ring in the second rotation angle range is converted into an axial movement for acting on the friction clutch.

15. ) The drive assembly according to claim 1,
wherein indexing means are provided to define a zero-point position of the ramp mechanism in the initial rotation angle.

16. The drive assembly according to claim 1,
wherein the valve is aligned tangentially to the actuating element.
